(19) United States
(12) Patent Application Publication
(10) Pub. No.: US 2013/0007103 A1
(43) Pub. Date: Jan. 3, 2013

(54) Managing Interactive Content on Client Devices

(75) Inventors: Alan David Braun, Randolph, NJ (US); Thomas Gabriel Adcox, Austin, TX (US)

(73) Assignee: APPLE INC., Cupertino, CA (US)

(21) Appl. No.: 13/174,635

(22) Filed: Jun. 30, 2011

(51) Int. Cl. G06F 15/16

(52) U.S. Cl. 709/203

(57) ABSTRACT

An interactive content management system and method is disclosed that allows an administrator operating a server device to manage the presentation of interactive content on client devices that are in communication with the server device. The communication can be through wired or wireless networks. Client users can interact with the content independent of the administrator or other client users. This allows each client user to interact with the content at the client user's own pace. The server device can be configured to allow the administrator to see what each client user is seeing on their respective client devices. The interactive content can include any type of content, including active links to other content available on the Web or from other content sources. The administrator can send specific content to specific client users or the same content to all client users.

### TECHNICAL FIELD

This disclosure relates generally to multimedia presentation applications.

### BACKGROUND

A multimedia presentation program is a computer software package used to display multimedia (e.g., digital pictures, video, audio, text, graphic art) to participants of a meeting or other event. A typical program includes an editor that allows content to be selected, inserted and formatted and a system to display the content.

Conventional multimedia presentation programs allow a presenter to provide the same content to a number of participants simultaneously. Participants often cannot interact with the content because the content is “read only.” Moreover, the presenter has complete control over the pace of the presentation, which can frustrate participants who may feel the content is being presented too fast or too slow. Because of these flaws, a presentation generated by a conventional multimedia presentation program often fails to engage and excite participants and thus ultimately fails the intended purpose of the presentation.

Modern mobile devices, such as smart phones and electronic tablets, incorporate various wireless technologies that allow real time communication with local (e.g., peer-to-peer) and networked devices (e.g., WiFi access points). Additionally, these modern mobile devices provide program developers with exciting new graphics and input technologies, such as animated user interfaces and multitouch displays. These mobile device capabilities can be leveraged to create dynamic and interactive presentations that inspire participants.

### SUMMARY

An interactive content management system and method is disclosed that allows an administrator operating a server device to manage the presentation of interactive content on client devices that are in communication with the server device. The communication can be through wired or wireless networks (e.g., peer-to-peer networks). Client users can interact with the content independent of the administrator or other client users. This allows each client user to interact with the content at the client user's own pace. The server device can be configured to allow the administrator to see what each client user is seeing on their respective client devices. The interactive content can include any type of content, including active links to other content available on the Web or from other content sources. The administrator can send specific content to specific client users or the same content to all client users.

In one aspect, each client device displays a user interface element that can be independently activated by a client user to display an agenda that is automatically updated by the server device as the presentation progresses.

In another aspect, each client device displays a user interface element that can be independently activated by a client user to indicate to the administrator that follow-up questions are requested by the client user.

In another aspect related to program development, static or dynamic objects are displayed on client devices, together with code snippets for creating or animating the static or dynamic objects. Thus, a client user can see in real time how a given code snippet creates or animates a given object. Each client user can interact with different objects and code snippets at their own pace, independent of other the administrator or other client users.

In another aspect, content (e.g., text, video, audio) can be navigated by client users independent of the administrator or other client users. The navigation can include multitouch gesturing.

In another aspect, the administrator can send a survey form with questions to be answered by the client users at any point in the presentation or meeting. Each client user can fill out the survey and submit their answers. The server device automatically aggregates the survey data and generates a summary report.

Particular implementations of the disclosed implementations provide one or more of the following advantages: 1) improved presentations for meetings and other applications are provided through interactive content that can be navigated or manipulated by client users independent of the serving device and other users, thus allowing each client user to control the pace of their own exploration of the interactive content; 2) presentations with interactive content can be prepared and delivered to client users using relatively inexpensive mobile devices (e.g., electronic tablets) and standardized communication technologies, thus avoiding the burden of purchasing or leasing dedicated videoconferencing or projection systems; 3) the ability for client users to signal their need for follow-up information without disrupting the presentation; and 4) the ability to electronically aggregate information (including survey data) and provide a summary report of the information immediately following the presentation.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 illustrates an exemplary interactive content management system for delivering interactive content from a server device to multiple client devices.

FIG. 2 is an exemplary login page for display on client devices.

FIG. 3 is an exemplary participant page for display on the server device.

FIG. 4 is an exemplary administrative page for display on the server device.

FIG. 5 illustrates an exemplary agenda/topics display feature available on client devices.

FIG. 6 illustrates exemplary independent interactive content delivery

FIG. 7 illustrates an exemplary software program development presentation for learning animation.

FIG. 8 illustrates exemplary independent interactive video.

FIG. 9 illustrates exemplary independent document navigation.

FIGS. 10A and 10B illustrate an exemplary software program development presentation for learning APIs.

FIGS. 11A and 11B illustrate an exemplary survey feature.

FIG. 12 illustrates an exemplary feature for allowing an administrative user to manage interactive content on client devices.

FIG. 13 is a flow diagram of an exemplary process for managing interactive content on client devices.

FIG. 14 is a block diagram of an operating environment for the interactive content management system.

FIG. 15 is a block diagram of an exemplary device architecture that implements the features and processes described with reference to FIG. 13.

FIG. 16 is a block diagram of an exemplary interactive content management system including work groups.

FIG. 17 is a block diagram of the exemplary interactive content management system shown in FIG. 16, including concepts of failover or clustering.

FIG. 18 is a block diagram of an exemplary interactive content management system including two server devices.

FIG. 19 is a block diagram of an exemplary interactive content management system where any device can be the server device.

Like reference-symbols in the various drawings indicate like elements.

### DETAILED DESCRIPTION

### Exemplary Interactive Content Management System

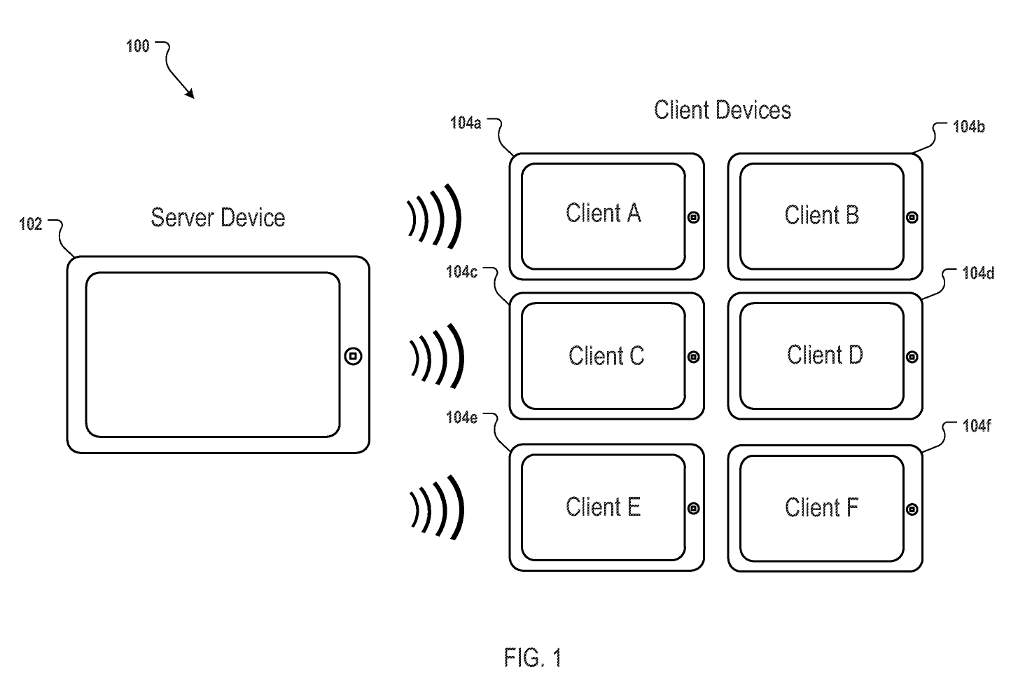

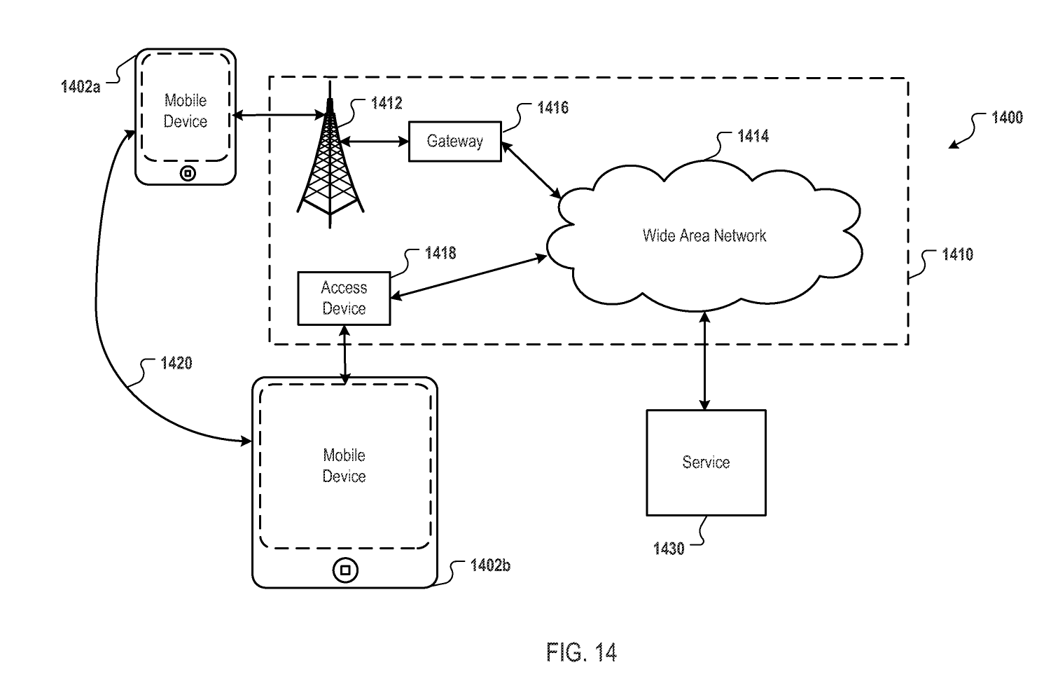

FIG. 1 illustrates an exemplary interactive content management system 100 for delivering interactive content from a server device 102 to multiple client devices 104. In the example shown, server device 102 is communicating with client devices 104a-104f over a wireless network. Although six client devices are shown any number of client devices can be included in system 100. Server 102 and client devices 104 can be any electronic device with capability to communicate with other electronic devices and to present interactive content, including but not limited to: smart phones, electronic tablets, television systems, notebook computers, desktop computers and the like. Server device 102 can communicate with client devices using any known, suitable wired and/or wireless technology or protocol. Communications can be peer-to-peer or over a local area network (LAN) or wide area network (WLAN), as described in reference to FIG. 14.

System 100 can be used in a variety of applications. For example, system 100 can be used to provide presentations for various business or social meetings or other events (e.g., tradeshows, sales presentations). System 100 can also be used in educational settings, such as classrooms and training centers. Client devices 104 can include mobile devices that are distributed to participants of the meeting or event, or are personal devices of the participants. The latter scenario provides flexibility and reduced administrative cost since many participants will own at least one mobile device that is a suitable client device 104 in system 100. Moreover, participants will likely be familiar with their own personal devices, thus eliminating the need to train participants on the basic operations of their client device 104.

In operation, server device 102 is operated by an administrator who will be providing the interactive content to client users. Some examples of administrators would be a presenter at a meeting or an educator in a classroom setting. Some examples of client users would be customers or students. In general, system 100 is applicable to any scenario where interactive content is presented to multiple participants in a controlled manner.

In some implementations, the interactive content and/or configuration data can be pre-installed on client devices 104. In these cases, the administrator may provide client devices 104 to client users with pre-installed interactive content or configuration data. In other implementations, the interactive content/configuration can be “pushed” from server device 102 to client devices 104 before and/or during the presentation. In other implementations, interactive content/configuration data can be “pulled” before or during the presentation from a server computer of network-based service, such as service 1430 shown in FIG. 14.

Some advantages of system 100 over conventional video conference or Web-based systems, is the ability of an administrator to: 1) selectively initiate presentations of different interactive content to different client users; 2) selectively see current views of client displays to monitor progress; and 3) to receive feedback from client users during and after the presentation. Other advantages will be discussed in reference to other figures.

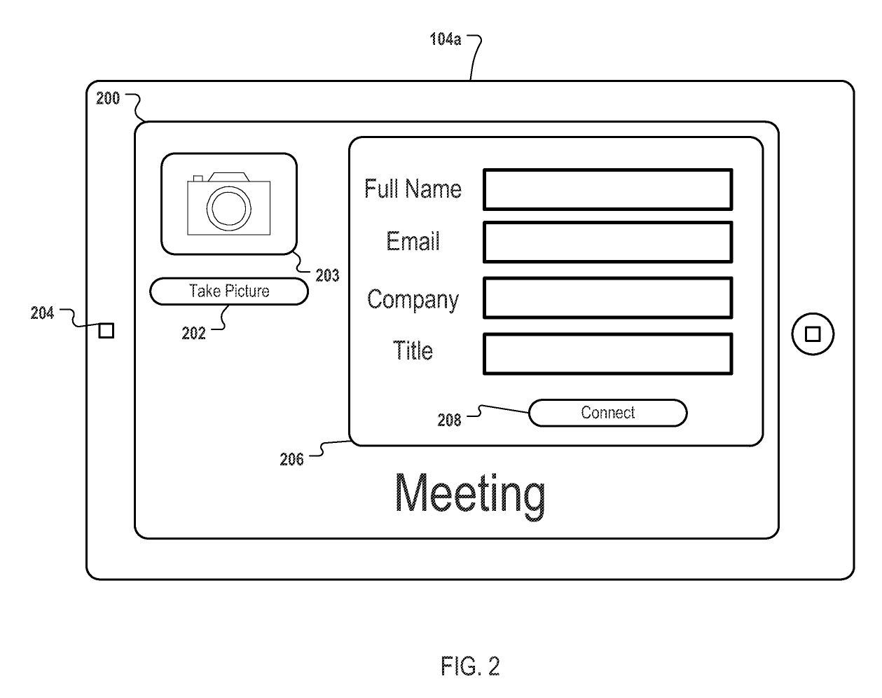

FIG. 2 is an exemplary login page 200 for display on client devices 104. Only device 104a is shown. Other client devices 104b-104f would have a similar login page.

In some implementations, each client user would be presented with login page 200 and asked to fill in some personal information, including but not limited to: full name, e-mail, company name and title. Text boxes can be provided for this purpose. When the information has been entered, the client user can touch or click connect button 208 to submit the information and join the meeting. In some implementations, where device 104a includes an embedded digital capture device 204 (or is coupled to a digital capture device), each client user can take their picture by touching or clicking on “Take Picture” button 202. The captured image of the user can be displayed in photo area 203.

The data collected during the logon process described above can be used in introductions as well as a summary report at the end of the meeting. The summary report can include participant information collected in the login process. The summary report can be sent to other individuals or entities. For a seminar presentation in which educational credits are awarded (medical and legal seminars), the summary report can be used to certify attendance by the participants.

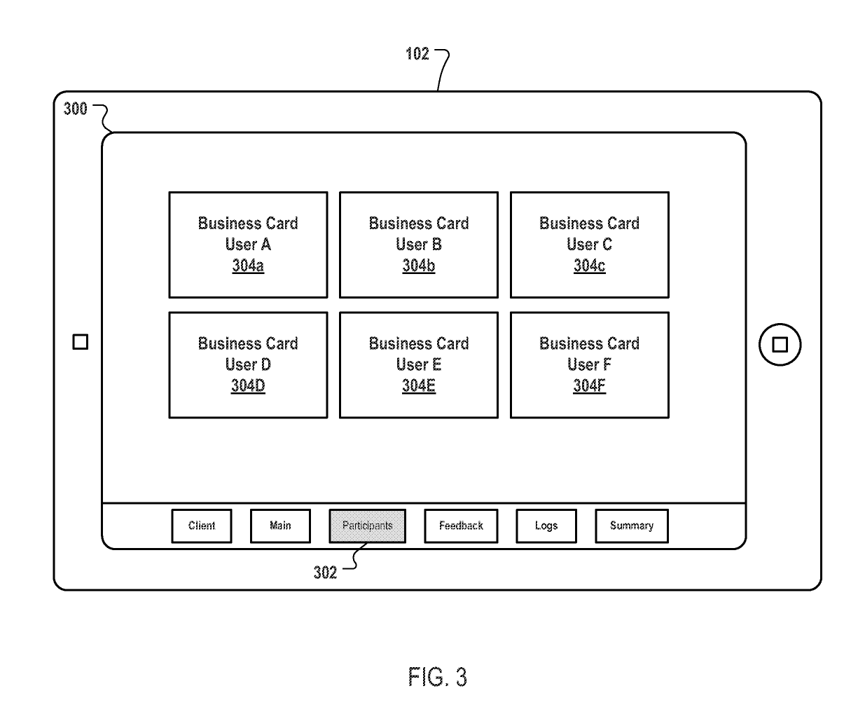

FIG. 3 is an exemplary participant page 300 for display on the server device 102. After the login process completes, the administrator can touch or click on “participants” button 302. In some implementations, virtual business cards 304a-304f for each client user is displayed in a grid on server device 102. Virtual business cards 304 can include information about corresponding client users and include the pictures taken during the login process. This page can be presented on client devices and used during an introduction or “ice breaker” part of the presentation.

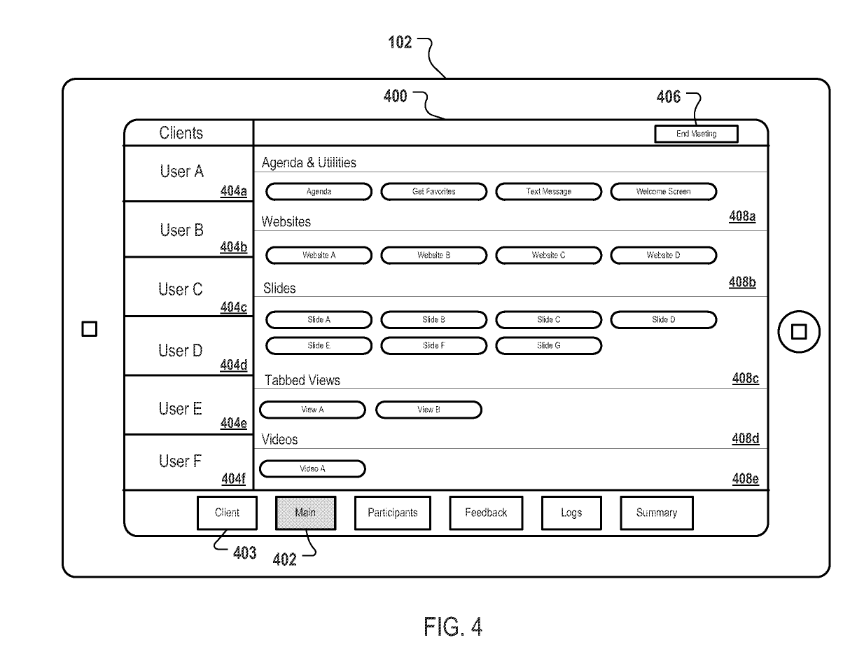

FIG. 4 is an exemplary server control panel 400, which is displayed on server device 102 when “Main” button 402 is touched or clicked. Server control panel 400 includes a sidebar of client user information 404a-404f that can be individually selected by the administrator to perform specific tasks associated with the selected client user.

Panel 400 also includes categories 408a-408e. Generally, categories will be determined based on the content and organization of the presentation, and will likely change from presentation to presentation. In the example shown, some example categories include but are not limited to: “Agenda & Utilities,” “Websites,” “Slides,” “Tabbed Views” and “Videos.” Under each category header are buttons for invoking interactive content related to the category header description.

Under category “Agenda & Utilities,” there is an “Agenda” button for updating the agenda on client devices 104, a “Get Favorites” button for retrieving content that was previously designated as favorite, a “Text Message” button for invoking a text message session with one or all client devices 104 and a “Welcome Screen” button for displaying a welcome screen on client devices 104.

Under category “Websites,” there are buttons for initiating the presentation of Web pages of particular websites to one or more client devices 140. The Uniform Resource Locator (URL) or Internet Protocol (IP) address to a website can be provided by server device 102 or preinstalled on client devices 104 and invoked by server device 102 when the button is touched or clicked. Each website can be navigated by a client user independently of the administrator or other client users in communication with server device 102.

Under category “Slides,” there are buttons for initiating the presentation of slides on one or more client devices 104. Each slide can be interacted with by a client user independently of the administrator or other client users in communication with server device 102.

Under category “Tabbed Views,” there are buttons for initiating the presentation of tabbed views on one or more client devices 104. Each tabbed view can be navigated by a client user independently of the administrator or other client users in communication with server device 102.

Under category “Videos,” there are buttons for initiating the presentation of videos on one or more client devices 104. Each video can be navigated by a client user independently of the administrator or other client users in communication with server device 102.

Other features of server control panel 400 include an “End Meeting” button 406 for ending the meeting/presentation and a “client” button 403 that when selected gives the administrator the ability to see what the client users are seeing on their respective client devices 104. The individual client device screen views can be displayed in a grid or other display format on server device 102.

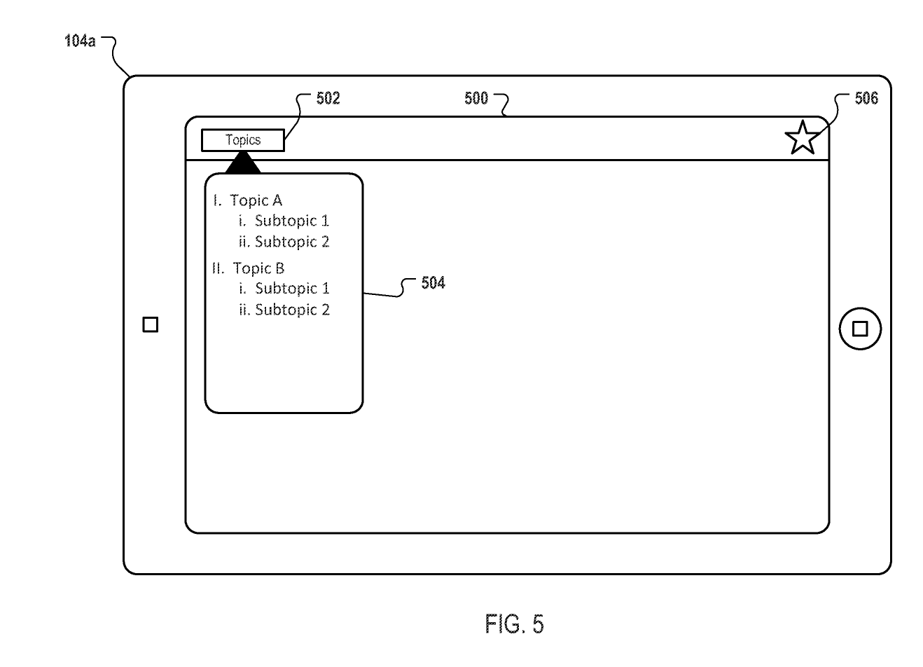

FIG. 5 illustrates an exemplary topics display feature available on client devices 104. In some implementations, user interface 500 can include “Topics” button 502, which when selected by a client user displays a list/outline of topics for the presentation that have been covered. The list/outline can be automatically updated as the presentation progresses. Accordingly, each client user can touch or click Topics button 502 to remind the client user of the current topic being discussed or presented. Prior to commencement of the meeting, Topics button 502 can be touched or clicked to present an agenda or topics to be covered during the presentation. Once the meeting commences, selecting Topics button 502 reveals the current topic of discussion, which is automatically updated by the administrator as the presentation progresses.

In some implementations, a “Follow-up” button 506 is included in user interface 500 that can be selected by a client user during the presentation to make a request that the administrator follow-up on the current topic being discussed after the presentation when button 506 is touched or clicked. This provides a mechanism for “bookmarking” sections of a presentation that can be used by the administrator in a follow-up session, such as a questions and answers session.

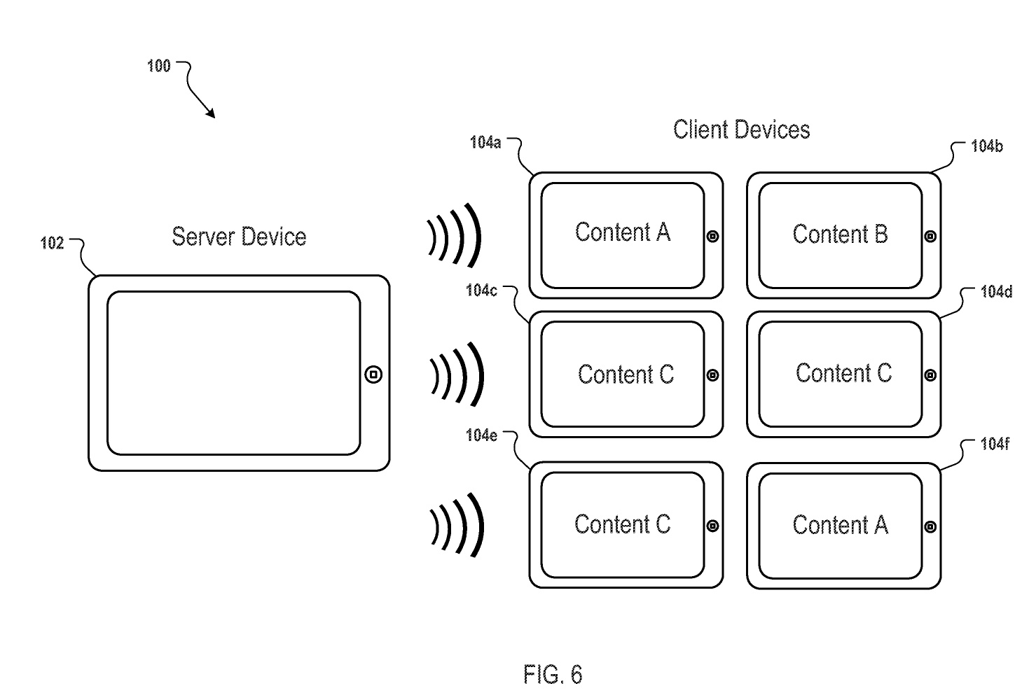

FIG. 6 illustrates exemplary independent interactive content delivery. As previously described in reference to FIGS. 1 and 4, the administrator can send different content to different client devices or the same content to some client devices or all the client devices. This allows the administrator to tailor content to particular participants based on a variety of reasons, including but not limited to the role or rank of the client user, the security clearance or access level of the client user, the learning level or rate of the client user, etc. For example, based on a client user's authorization the client device would render different charts and allow for different “drill downs” into the charts. In this case, a CEO may be allowed to access or interact with different content (or more relevant content for a CEO) than a business unit director. In the example shown, client devices 104a, 104f are viewing interactive content A, client device 104b is viewing interactive content B and client devices 104c, 104d, 104e are viewing content C.

In the above example, client users can be interacting with different Web pages using active links None of client devices 104 is synchronized with server device 102 or with each other. Client users of client devices 104c, 104d and 104e can be viewing a home page of a website, while client users of client devices 104a, 104f can be viewing other pages of the website. The client user of client device 104b can be viewing an entirely different website.

In some implementations, client devices 104 can have split screens where only half the screen can be managed by server device 102, leaving the other half to be used by the client user as desired. For example, a split screen may allow client users to take notes during a meeting. Server device 102 can then capture the notes or allow client users to send the notes via email when the meeting is over. In another use case, server device 102 can control both screens of the split screen and send different content to different screens at different paces.

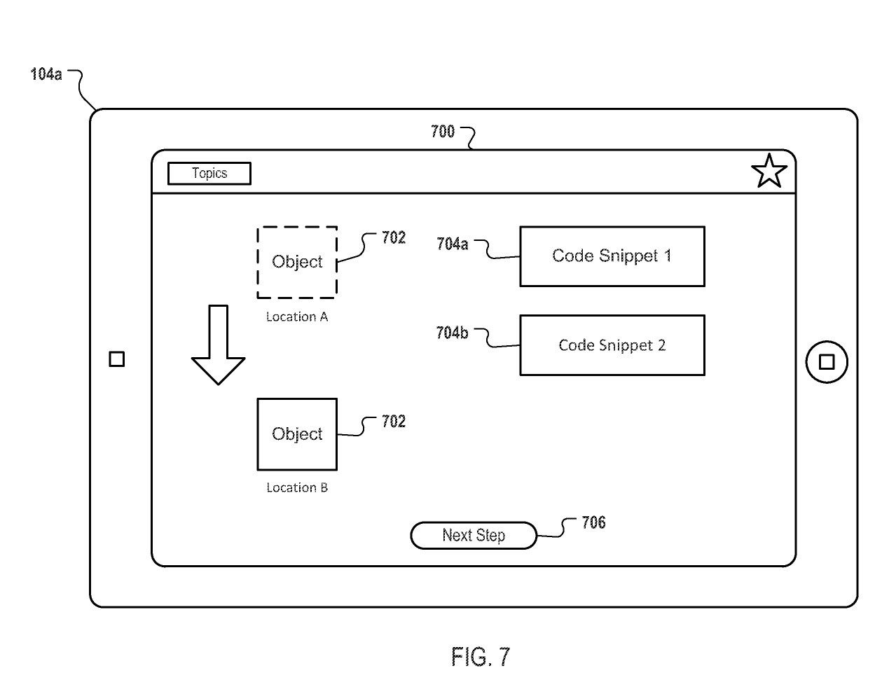

FIG. 7 illustrates an exemplary software program development presentation for learning animation. In some presentations, it is desirable to show participants a “cause and effect” relationship. This can occur when training software program developers how to write code to make a graphical object animate. In the example shown, participants (client users) can see graphical object 702 move from location A to location B on their respective screens and see the corresponding code snippet 704a that causes the object 702 to move to location B. By touching or clicking “Next Step” button 706, the participant can step through each section of code and see the object change state and the corresponding code snippet that causes the state change. Such interactive content allows the user to see the cause and effect of code snippets and aids in the learning process, while also improving the learning experience.

This cause and effect interaction can be applied to other presentations as well. For example, a participant in a cooking class can step through pictures of stages of food preparation with the display of corresponding recipe steps for each stage, thus providing an interactive learning experience for the participants. In another example, pictures of an item being assembled can be stepped through in stages with corresponding instructions displayed next to the pictures. In one example use case, two designs (e.g., mobile device applications) can be displayed side-by-side on a client device; one showing a good design and one showing a bad design.

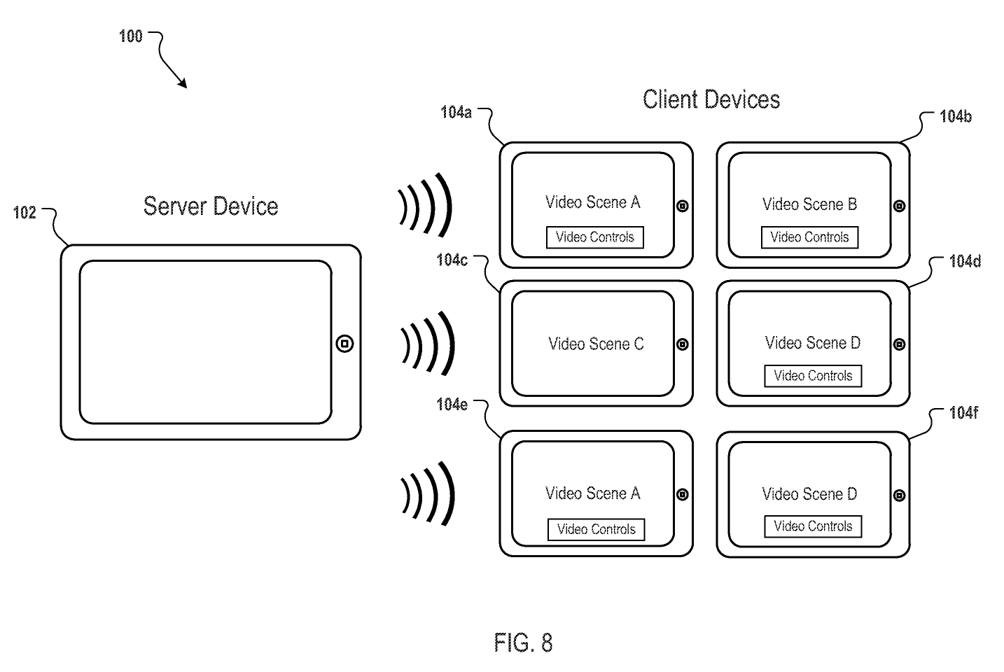

FIG. 8 illustrates exemplary independent interactive video. In some implementations, interactive content can be video (or slide show or audio) that can be navigated independently by each client user. That is the client devices are not synchronized by server device 102. In the example shown, each client user has been presented with a video and a video control. Each client user can independently navigate the video using the video control, such as forward, reverse, stop, play, pause, etc. Here, client devices 104a, 104e are showing video scene A, client devices 104d, 104f are showing video scene D, client device 104b is showing video scene B and client device 104c is showing video scene C. Additionally, each of the client devices 104 can be showing a different video as well as different video scenes. Using this feature, client users can explore a video at their own pace and navigate scenes as desired. If client devices 104 include touch sensitive pads or screens, then each client user can navigate with gestures such as swiping new pages into screen view, etc.

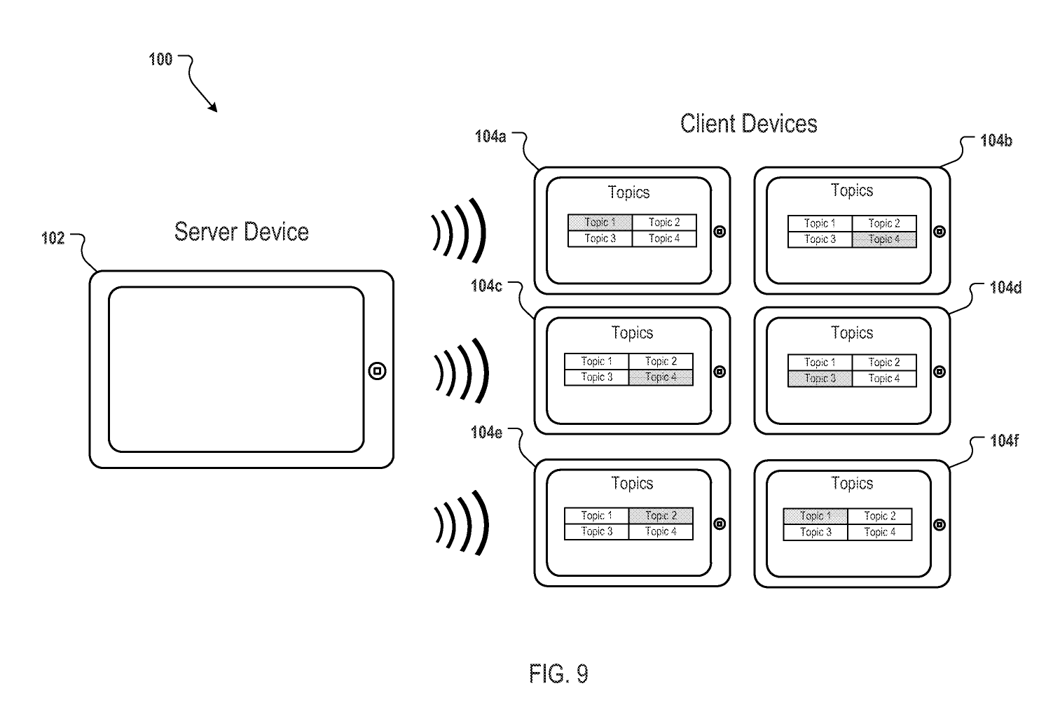

FIG. 9 illustrates exemplary independent document navigation. In some implementations, the interactive content can be a document with topics or a table of contents or other type of directory. Each client user can navigate different topics, chapters or levels of content independently of server device 102 and other client devices. In the example shown, users of client devices 104a, 104f have independently selected Topic 1 to review. Users of client devices 104b, 104c have independently select Topic 4 to review. A user of client device 104d has independently selected Topic 3 to review. A user of client device 104e has independently selected Topic 2 to review.

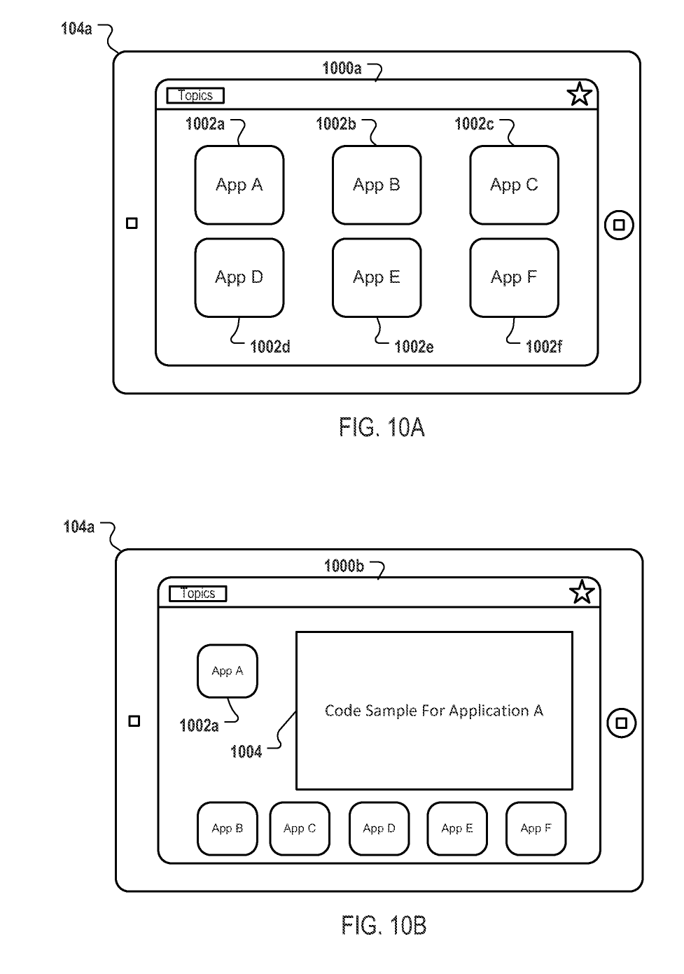

FIGS. 10A and 10B illustrate an exemplary software program development presentation for learning APIs. In FIG. 10A, client users are presented with display 1000a including a number of icons 1002a-10002f that indicate an application for which an Application Programming Interface (API) is available. In the example shown, a user of client device 104a selects icon 1002a. This selection causes display 1000b shown in FIG. 10B, where icon 1002a is reduced in size and moved to the left of the screen, sample code 1004 for the API is displayed next to icon 1002a and the other icons 1002b-1002f are moved to a horizontal row at the bottom of screen 1000b.

This interactive scenario can be extrapolated to any content type, where there is an object or icon that represents a person, place or thing for which there is information available. For example, an example interactive learning application could display a map of a continent, allowing a student to touch a country to display information about the country. Such an application could be useful for an interactive lesson in a geography or history.

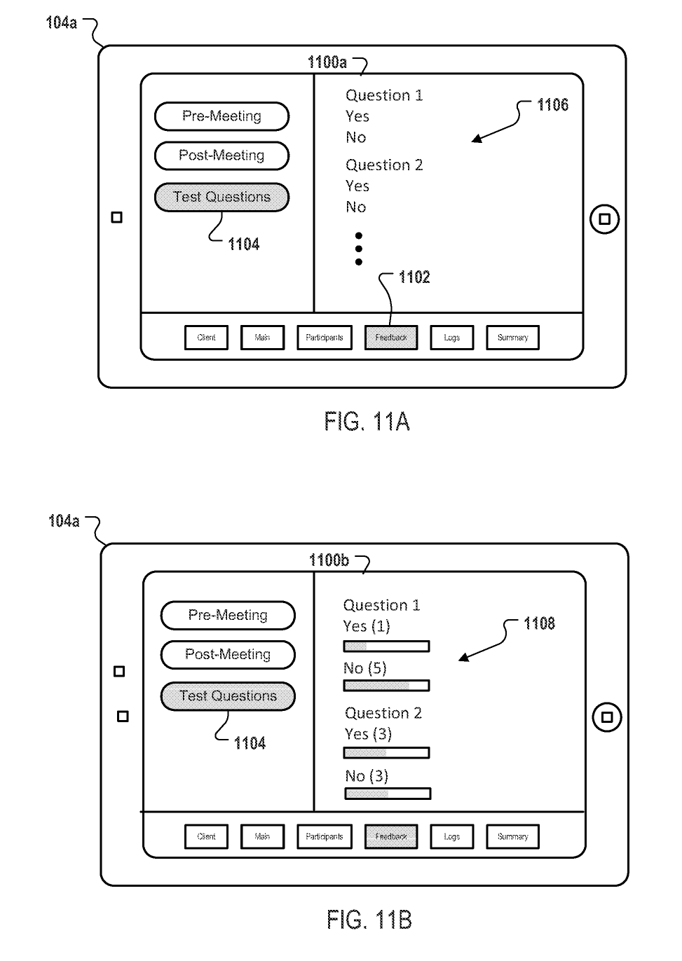

FIGS. 11A and 11B illustrate an exemplary survey feature. In some implementations, server device 102 can provide a survey to participants via client devices 104. An example survey format is shown in FIG. 11A. The survey feature can be invoked when a client user touches or clicks the “Feedback” button 1102.

The client user can select one of several feedback types, including but not limited to: pre-meeting feedback, post-meeting feedback and test questions. In this example, test questions are selected by an administrator on server device 102, resulting in test questions being presented on client device 104a for the client user to answer. In this feedback format, the client user is asked yes or no questions; however, any question and answer format can be used as desired.

The answers received by server device 102 can be formatted for display as shown in FIG. 11B. In the example shown, the yes and no questions were aggregated and displayed with bar graphs. Other display formats are also possible. The results can be submitted as part of a summary report generated by server device 102.

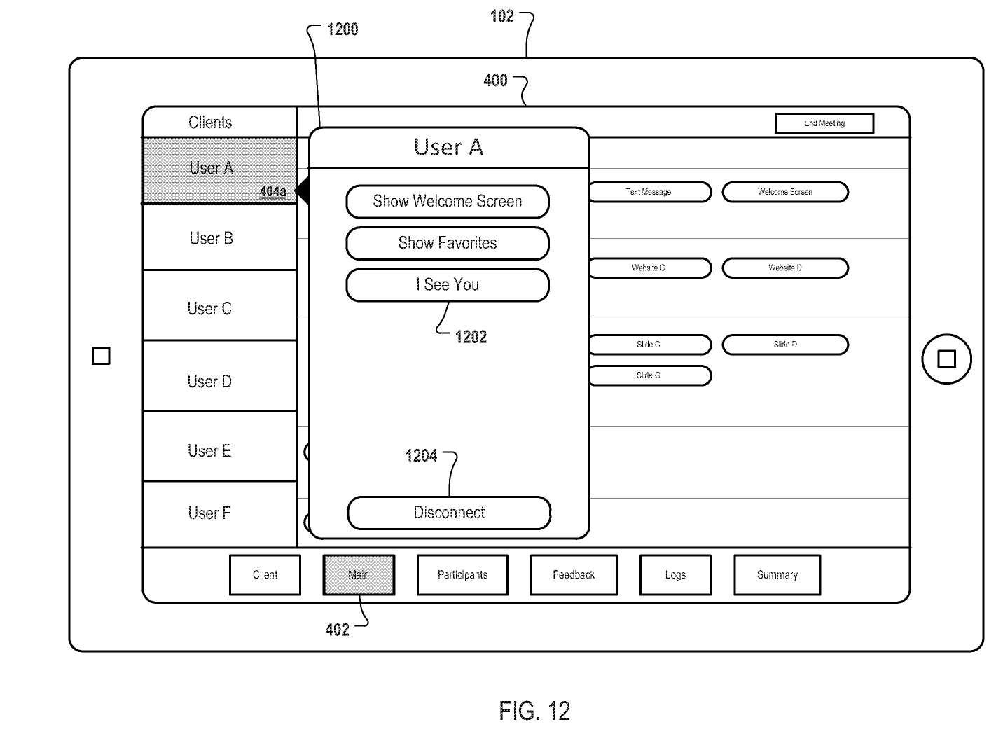

FIG. 12 illustrates an exemplary feature for allowing an administrative user to manage interactive content on client devices. As previously described, the administrative user can selectively send specific content to specific client users. The client devices do not have to be synchronized. The interactive content can be different or the same. Client users can interact with the content at their own pace independent of the administrator or other client users.

In some implementations, the administrator can select a client user 404 (e.g., client user 404a) in server control panel 400 to manage a specific client device independent of other client devices. When the client device is selected, pane 1200 appears with several management options. Some examples of management options include but are not limited to, “Show Welcome,” “Show Favorites” and “I See You.” Each of these options has a corresponding button that can be touched or clicked to select the option. The “I See You” option allows the administrator to view into what the client user is looking at on the selected client device. Other management options can be included in pane 1200. A “Disconnect” button 1204 can be touched or clicked to disconnect the client device from the meeting/presentation.

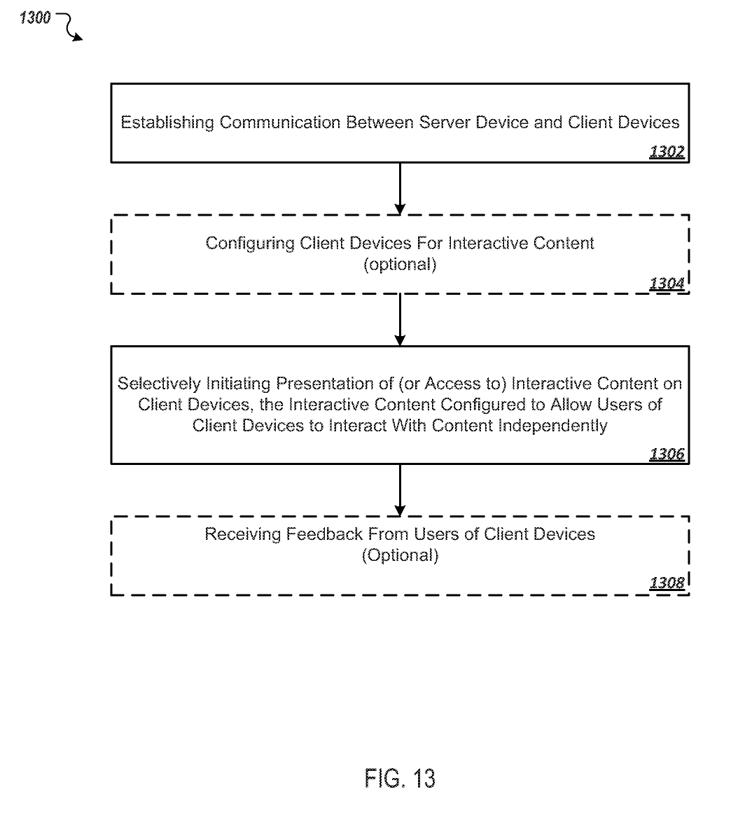

FIG. 13 is a flow diagram of an exemplary process 1300 for managing interactive content on client devices. In some implementations, process 1300 can begin by establishing communication between a server device and one or more client devices (1302). The communication can be wired or wireless (including ad hoc wireless) and any desired network configuration, such as peer-to-peer (e.g., using Bluetooth technology), LAN, WLAN (e.g., WiFi, Internet, Ethernet) or any other known network configuration. In peer-to-peer networks, server device 102 can initiate communication with wireless client devices after sensing the presence of the client devices.

Process 1300 can continue by optionally configuring client devices for receiving interactive content (1304). In some cases, the client devices can be preconfigured before the presentation occurs. In other cases, the client devices can be preconfigured by the server device or by a network service.

Process 300 can continue by selectively initiating presentation of (or access to) interactive content on client devices, where the interactive content is configured to allow users of client devices to access and interact with the content independently and at their own pace (1306). For example, pane 1200 (FIG. 12) can be used to send specific content to specific client devices. The content can be any type of content, including but not limited to: documents, video, audio, slides, webpages, tabbed views, etc.

Process 300 can continue by optionally receiving feedback from users of client devices (1308). Feedback can be initiated by client users, such as selecting “Follow-up” button 506 (FIG. 5) to indicate that follow-up after the presentation is requested. Feedback from client users can be requested by a server device using a survey format or other suitable feedback format. Feedback can be included in a summary report provided to other individuals or entities after the meeting/presentation concludes.

### Exemplary Operating Environment

FIG. 14 illustrates an exemplary operating environment 1400 for a mobile device that implements the interactive content management system 100 of FIG. 1. In some implementations, mobile devices 1402a and 1402b can for example, communicate over one or more wired and/or wireless networks 1410 in data communication. For example, a wireless network 1412, e.g., a cellular network, can communicate with a wide area network (WAN) 1414, such as the Internet, by use of a gateway 1416. Likewise, an access device 1418, such as an 802.11g wireless access device, can provide communication access to the wide area network 1414.

In some implementations, both voice and data communications can be established over wireless network 1412 and the access device 1418. For example, mobile device 1402a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 1412, gateway 1416, and wide area network 1414 (e.g., using Transmission Control Protocol/Internet Protocol (TCP/IP) or User Datagram Protocol (UDP)). Likewise, in some implementations, the mobile device 1402b can place and receive phone calls, send and receive e-mail messages, and retrieve electronic documents over the access device 1418 and the wide area network 1414. In some implementations, mobile device 1402a or 1402b can be physically connected to the access device 1418 using one or more cables and the access device 1418 can be a personal computer. In this configuration, mobile device 1402a or 1402b can be referred to as a “tethered” device.

Mobile devices 1402a and 1402b can also establish communications by other means. For example, wireless mobile device 1402a can communicate with other wireless devices, e.g., other mobile devices 1402a or 1402b, cell phones, etc., over the wireless network 1412. Likewise, mobile devices 1402a and 1402b can establish peer-to-peer communications 1420, e.g., a personal area network, by use of one or more communication subsystems, such as the Bluetooth™ communication devices. Other communication protocols and topologies can also be implemented.

The mobile devices 1402a or 1402b can for example, communicate with service 1430 over the one or more wired and/or wireless networks. For example, service 1430 can provide various services for administrating the interactive content management system, including but not limited to storing and delivering configuration information to client devices.

Mobile device 1402a or 1402b can also access other data and content over the one or more wired and/or wireless networks. For example, content publishers, such as news sites, Really Simple Syndication (RSS) feeds, web sites, blogs, social networking sites, developer networks, etc., can be accessed by mobile device 1402a or 1402b. Such access can be provided by invocation of a web browsing function or application (e.g., a browser) in response to a user touching, for example, a Web object.

### Exemplary Device Architecture

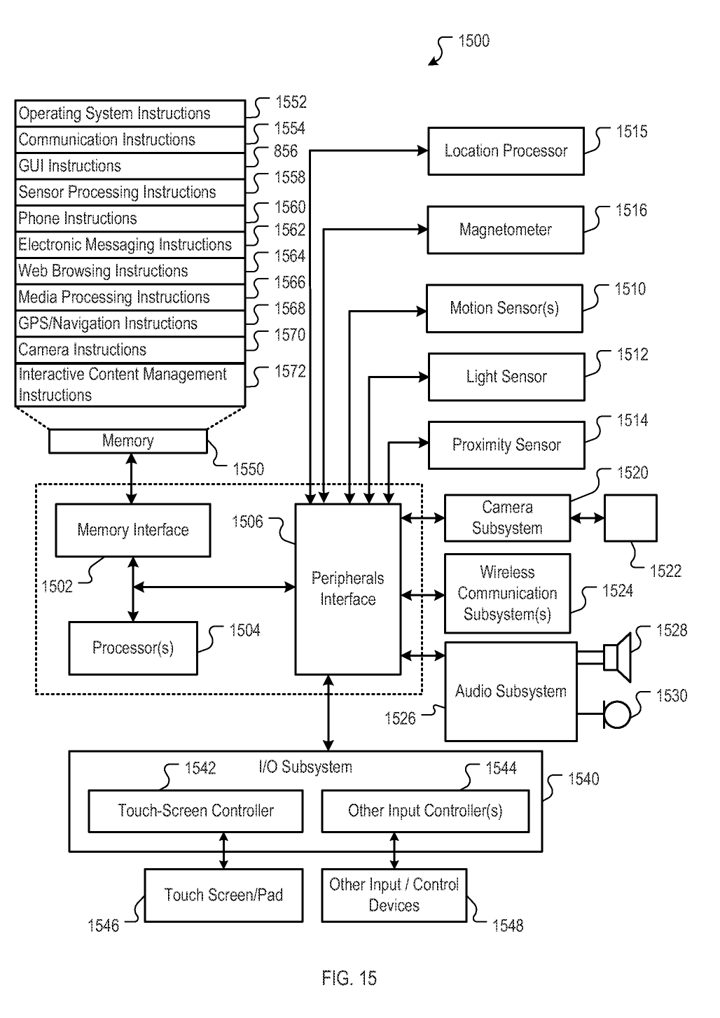

FIG. 15 is a block diagram illustrating exemplary device architecture that implements features and processes described in reference to FIGS. 1-13. Device 1500 can be any location aware device including but not limited to smart phones and electronic tablets. Device 1500 can include memory interface 1502, data processor(s), image processor(s) or central processing unit(s) 1504, and peripherals interface 1506. Memory interface 1502, processor(s) 1504 or peripherals interface 1506 can be separate components or can be integrated in one or more integrated circuits. The various components can be coupled by one or more communication buses or signal lines.

Sensors, devices, and subsystems can be coupled to peripherals interface 1506 to facilitate multiple functionalities. For example, motion sensor 1510, light sensor 1512, and proximity sensor 1514 can be coupled to peripherals interface 1506 to facilitate orientation, lighting, and proximity functions of the mobile device. For example, in some implementations, light sensor 1512 can be utilized to facilitate adjusting the brightness of touch screen 1546. In some implementations, motion sensor 1510 (e.g., an accelerometer, gyros) can be utilized to detect movement and orientation of the device 1500. Accordingly, display objects or media can be presented according to a detected orientation, e.g., portrait or landscape.

Other sensors can also be connected to peripherals interface 1506, such as a temperature sensor, a biometric sensor, or other sensing device, to facilitate related functionalities.

Location processor 1515 (e.g., GPS receiver) can be connected to peripherals interface 1506 to provide geo-positioning. Electronic magnetometer 1516 (e.g., an integrated circuit chip) can also be connected to peripherals interface 1506 to provide data that can be used to determine the direction of magnetic North. Thus, electronic magnetometer 1516 can be used as an electronic compass.

Camera subsystem 1520 and an optical sensor 1522, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 1524. Communication subsystem(s) 1524 can include one or more wireless communication subsystems. Wireless communication subsystems 1524 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 1524 can depend on the communication network(s) or medium(s) over which device 1500 is intended to operate. For example, a mobile device can include communication subsystems 1524 designed to operate over a GSM network, a GPRS network, an EDGE network, a WiFi or WiMax network, and a Bluetooth network. In particular, the wireless communication subsystems 1524 can include For example, device 1500 may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 1524 may include hosting protocols such that the mobile device 1500 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 1526 can be coupled to a speaker 1528 and one or more microphones 1530 to facilitate voice-enabled functions, such as voice recognition, voice replication, digital recording, and telephony functions.

I/O subsystem 1540 can include touch screen controller 1542 and/or other input controller(s) 1544. Touch-screen controller 1542 can be coupled to a touch screen 1546 or pad. Touch screen 1546 and touch screen controller 1542 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen 1546.

Other input controller(s) 1544 can be coupled to other input/control devices 1548, such as one or more buttons, rocker switches, thumb-wheel, infrared port, USB port, and/or a pointer device such as a stylus. The one or more buttons (not shown) can include an up/down button for volume control of speaker 1528 and/or microphone 1530.

In one implementation, a pressing of the button for a first duration may disengage a lock of the touch screen 1546; and a pressing of the button for a second duration that is longer than the first duration may turn power to mobile device 1500 on or off. The user may be able to customize a functionality of one or more of the buttons. The touch screen 1546 can also be used to implement virtual or soft buttons and/or a keyboard.

In some implementations, device 1500 can present recorded audio and/or video files, such as MP3, AAC, and MPEG files. In some implementations, device 1500 can include the functionality of an MP3 player and may include a pin connector for tethering to other devices. Other input/output and control devices can be used.

Memory interface 1502 can be coupled to memory 1550. Memory 1550 can include high-speed random access memory or non-volatile memory, such as one or more magnetic disk storage devices, one or more optical storage devices, or flash memory (e.g., NAND, NOR). Memory 1550 can store operating system 1552, such as Darwin, RTXC, LINUX, UNIX, OS X, WINDOWS, or an embedded operating system such as VxWorks. Operating system 1552 may include instructions for handling basic system services and for performing hardware dependent tasks. In some implementations, operating system 1552 can include a kernel (e.g., UNIX kernel).

Memory 1550 may also store communication instructions 1554 to facilitate communicating with one or more additional devices, one or more computers or one or more servers. Communication instructions 1554 can also be used to select an operational mode or communication medium for use by the device, based on a geographic location (obtained by the GPS/Navigation instructions 1568) of the device. Memory 1550 may include graphical user interface instructions 1556 to facilitate graphic user interface processing, such as generating the user interfaces shown in FIGS. 2-5, 6, 10A-10B, 11A-11B and 12; sensor processing instructions 1558 to facilitate sensor-related processing and functions; phone instructions 1560 to facilitate phone-related processes and functions; electronic messaging instructions 1562 to facilitate electronic-messaging related processes and functions; web browsing instructions 1564 to facilitate web browsing-related processes and functions; media processing instructions 1566 to facilitate media processing-related processes and functions; GPS/Navigation instructions 1568 to facilitate GPS and navigation-related processes; camera instructions 1570 to facilitate camera-related processes and functions; and interactive content management instructions 1572 for implementing the features and processes described in reference to FIGS. 1-13. The memory 1550 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 1550 can include additional instructions or fewer instructions. Furthermore, various functions of the mobile device may be implemented in hardware and/or in software, including in one or more signal processing and/or application specific integrated circuits.

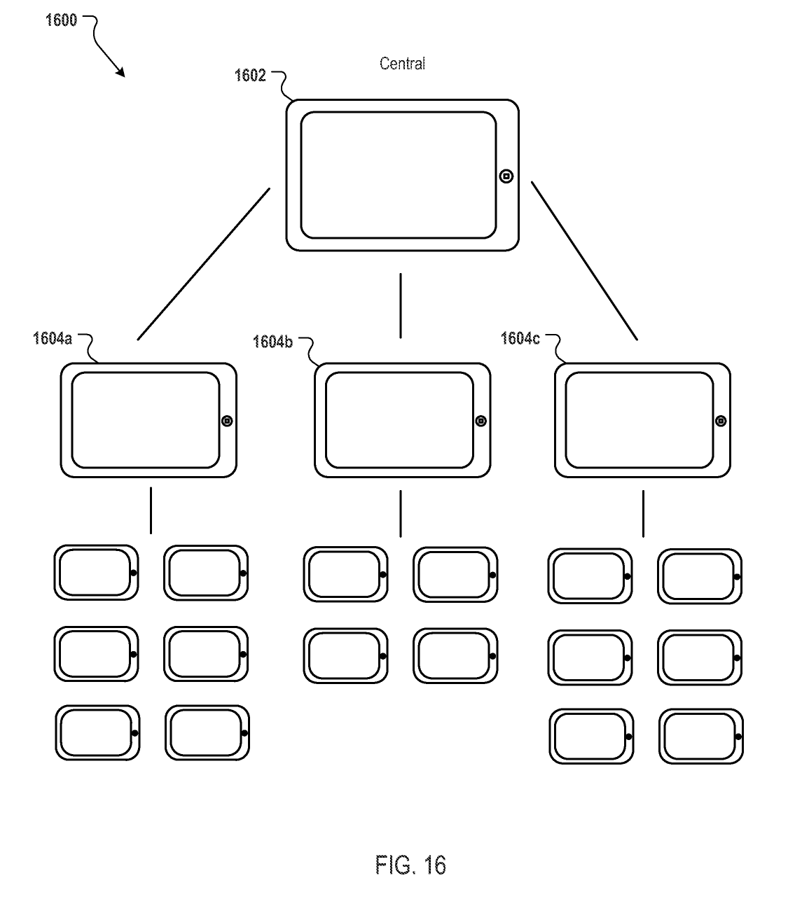

FIG. 16 is a block diagram of an exemplary interactive content management system 1600 including work groups. In some implementations, server device 1602 can be coupled to group client devices 1604a-1604c and act as a central server. In this arrangement, each group client device 1604 would be a server device for client devices in its respective group. Group server devices 1604 would then connect back to central server device 1602. Each “workgroup” could be in a different location. For example, central server device 1602 could be in Cupertino, Calif., and group server devices 1604a-1604c could be serving work groups in New York, Chicago and Atlanta, respectively. Each location could be doing things independently and then send status back to central server device 1602.

Another use scenario for system 1600 would be workgroups in a room. Participants of a meeting could be placed into groups to get a task done. The “Team Leader” can operate a workgroup server device 1604 and would coordinate activities with their team's client devices. When the team has completed a task, the “Team Leader” can communicate back to the central server device 1602. Thus, system 1600 provides a more flexible architecture to allow for scaling out of groups of presentations or activities, but still staying coordinated with a bigger meeting.

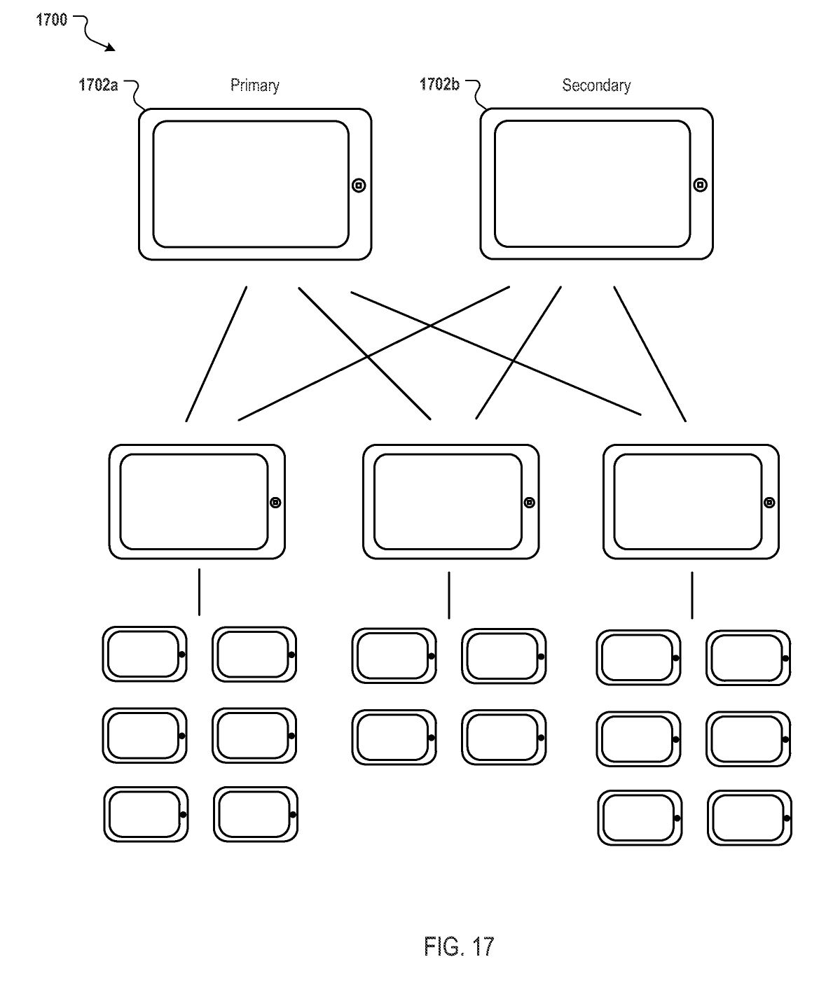

FIG. 17 is a block diagram of an exemplary interactive content management system 1700 including concepts of failover or clustering. In this implementation, there is primary server 1702a and secondary server 1702b. When primary server 1702a loses connectivity, secondary server device 1702b takes over control as the central server device, thus providing failover protection for system 1700.

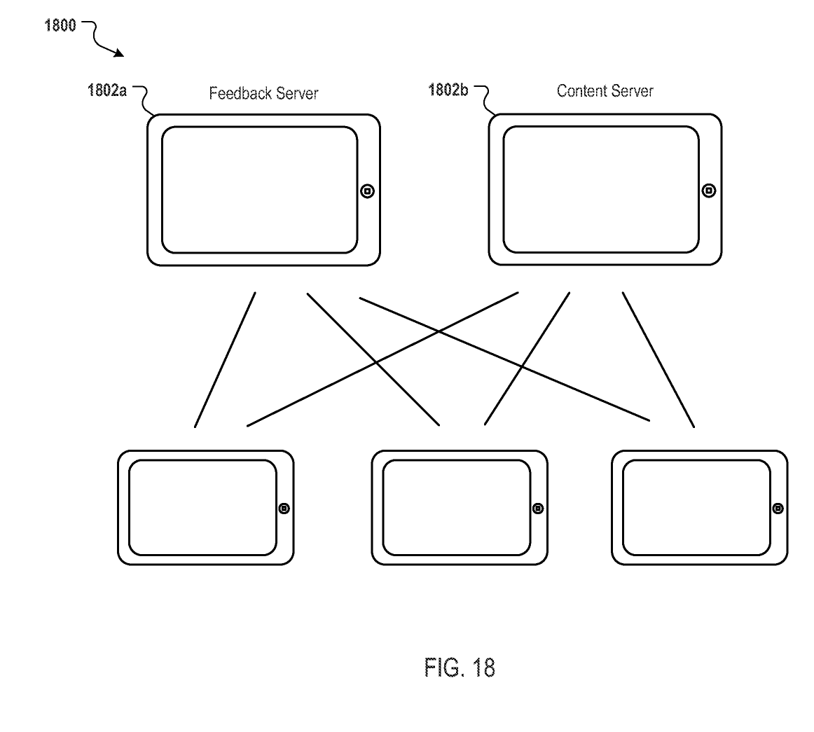

FIG. 18 is a block diagram of an exemplary interactive content management system 1800 including two server devices 1802a, 1802b. In this use scenario, each client device connects to server devices 1802a, 1802b, simultaneously. For example, server device 1802a can be a feedback or survey server and server device 1802b can be a content server. Feedback server device 1802a can be up on a projector at all times and control when to push out a specific survey. Content server device 1802b can be the device that is controlling the flow of a presentation. In a gaming situation, one device might be the leader board and the other device might be controlling what level or game board each user is seeing. In a classroom setting, one server might show the progress of the students while the other server controls the content to push out to the students.

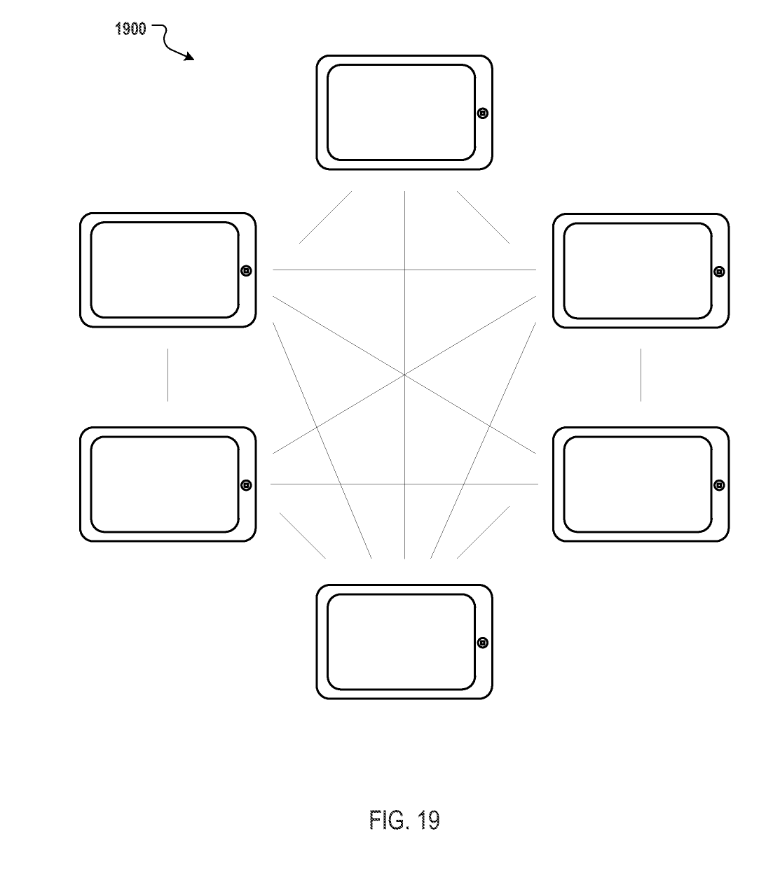

FIG. 19 is a block diagram of an exemplary interactive content management system 1900 where any device can be a server device. This is a clustered architecture that allows for passing control to another client device to become a server device. When the “new” server takes over control, the new server will have the ability to pass interactive content to the rest of the devices in the room. For example, assume there are five people in a meeting. At the start of the meeting, the administrator could create a whiteboard to everyone. At that point, the user could pass control to another user in the room. That recipient user might push a specific drawing out to the other participants in the room to annotate. All of the content on the devices is still interactive, but the user that initiates the content changes throughout the meeting.

### Other Use Cases

In some implementations, system 100 can be used to train personnel to repair equipment or machinery or design products. For example, a step-by-step process as previously described can be used with pictures and excerpts from training manuals. System 100 can also be used for interactive gaming. For example, if the devices have motion sensors then a group of client users could play maze or puzzle games.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include LAN, WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method performed by server device for managing interactive content running on client devices, the method comprising:
establishing communication with client devices; and
selectively managing interactive content on client devices, where the interactive content is configured to allow users of client devices to interact with the interactive content independent of the server device and other client devices in communication with the server device.

2. The method of claim 1, where selectively managing content further comprises:
selectively initiating the presentation of different content on different client devices.

3. The method of claim 2, where the content is selected by the server device based on the role or title of a client user or access restrictions associated with the client user.

4. The method of claim 1, where selectively managing content further comprises:
selectively initiating the presentation of specific interactive content to a specific client device.

5. The method of claim 1, where the interactive content includes active links to websites that can be selected by a user of a client device.

6. The method of claim 1, where the interactive content includes video with controls for allowing a user of a client device to navigate the video.

7. The method of claim 1, where the interactive content includes a number of tab views that can be selected individually by a user of a client device.

8. The method of claim 1, where the interactive content includes slides that can be navigated by a user of a client device.

9. The method of claim 1, where the interactive content includes a user interface element that can be selected by a user of a client device to display a topic or agenda on the client device.

10. The method of claim 1, where the interactive content includes a user interface that allows a user to step through program code corresponding to animation of a graphical object.

11. The method of claim 1, further comprising:
receiving feedback from one or more of the client devices.

12. The method of claim 11, where the feedback indicates that follow-up is requested by a user of a client device.

13. The method of claim 11, where the feedback is survey data.

14. The method of claim 1, further comprising:
configuring client devices for interactive content delivery.

15. The method of claim 14, where configuring client devices includes configuring client devices by preinstalling configuration data on the client devices prior to a presentation.

16. The method of claim 14, where configuring client devices includes configuring client devices from a server device or another network-based device.

17. A method performed by client device for managing interactive content running on the client device, the method comprising:
establishing communication with a server device; and
obtaining access to interactive content through the server device; and
receiving user input interacting with the content, where the interaction is independent of the server device and other client devices in communication with the server device.

18. The method of claim 17, where receiving user input interacting with the content, further comprises:
receiving user input selecting an active link to a website; and
presenting a web page corresponding to the selected active link in response to the user input.

19. The method of claim 17, where receiving user input interacting with the content, further comprises:
receiving user input for navigating video or slides; and
navigating the video or slides in response to the user input.

20. The method of claim 17, where receiving user input interacting with the content, further comprises:
receiving user input selecting a tab view from a number of tab views; and
displaying the selected tab view in response to the user input.

21. The method of claim 17, where receiving user input interacting with content, further comprises:
receiving user input requesting display of a topic or agenda; and
displaying the topic or agenda in response to the user input.

22. The method of claim 17, where receiving user input interacting with content, further comprises:
receiving user input stepping through program code sequence corresponding to animation of a graphical object; and
animating the graphical object at each step and displaying program code associated with the animating at each step of the sequence.

23. The method of claim 17, further comprising:
receiving user input requesting follow-up from an administrator operating the server device.
